(19) United States
(12) Patent Application Publication
(10) Pub. No.: US 2011/0060581 A1
(43) Pub. Date: Mar. 10, 2011

(54) METHOD FOR EVALUATING THE EXTENT OF THE PROTECTION AREA GRANTED BY A LIGHTNING CAPTURING DEVICE

(76) Inventors: Gèrard Maurice Berger, Palaiseau (FR); Sonia Aït-Amar, Orsay (FR)

(21) Appl. No.: 11/574,638

(22) PCT Filed: Sep. 1, 2005
(86) PCT No.: PCT/FR05/02184

§ 371 Date: Sep. 11, 2007

(30) Foreign Application Priority Data
Sep. 2, 2004 (FR) 0409318

(51) Int. Cl. G06G 7/62

(52) U.S. Cl. 703/13

(57) ABSTRACT

A method for evaluating the extent (D) of the protection area granted by a lightning capturing device (1) based on a leader stroke progression model wherein each leader stroke is modeled by a succession of electrically charged segments (6, 7, 8, 9, 10, 11, 12, 13, 14, 15). The method includes at least one step for verifying the junction between the downward leader stroke (4) and the upward leader stroke (3) during which the electric field is calculated along an imaginary line joining the downward leader stroke (4) and the upward leader stroke (3), and verifying that the electric field is greater than the minimum electric field necessary for the propagation of the upward leader stroke.

### PRIORITY CLAIM

This patent application is a U.S. National Phase of International Application No. PCT/FR2005/002184, filed Sep. 1, 2005, which claims priority to French Patent Application No. 0409318, filed Sep. 2, 2004, the disclosures of which are incorporated herein by reference in their entirety.

### FIELD OF THE INVENTION

The present invention relates to methods for evaluating the span of the area of protection, in particular, in the lateral direction, covered by lightning capture devices, such as a lightning conductor with a single rod or a priming device, multipoint devices or meshed cages.

The present invention relates more specifically to a method for evaluating the span of the area of protection covered by at least one lightning capture device. The lightning strike is by the propagation and the junction of an upward stroke and a downward stroke. The method is based on a stroke progression model in which each stroke is modelled by a series of electrically charged segments, each segment extending, in the direction of propagation, between a rear end and a front end.

The present invention also relates to a computer program including computer program coding means suitable for carrying out the steps of a method for evaluating the span of the area of protection covered by at least one lightning capture device, when the program is run on a computer.

The present invention also relates to a computer program as mentioned above, implemented on a computer-readable medium.

The present invention finally relates to a medium capable of being read by a computer and on which a computer program as mentioned above is recorded.

### BACKGROUND OF THE ART

To protect a building, a structure, equipment or, in general, any area in a geographical space, from the direct impact of lightning, a protection system is generally implemented, usually referred to as a “lightning conductor”, and including in particular the following three main elements: a capture device; a grounding device; and a ground conductor.

The capture device generally includes one or more rods or metal points, intended to be vertically positioned toward the sky and connected to the ground by means of the grounding device, which is formed by a conductor intended to conduct the lightning current from the rod to the ground conductor, while the ground conductor is itself intended to distribute the lightning current in the ground.

Such a device thus makes it possible to directly conduct the atmospheric discharges into the ground, preventing the atmospheric discharges from traversing the area to be protected, which could damage or destroy the area.

The operation of such a system may be as follows.

It is universally known that storm clouds are electrically charged. Ground flashes almost always begin in the cloud by a preliminary breakdown phenomenon. After several dozen milliseconds, this phenomenon creates a strongly branched negative discharge that is propagated by jumping from the cloud to the ground, which can be referred to as a “downward stroke” or a “jumping downward stroke”.

The ambient electrical field at the ground under the downward stroke then becomes very high and one or more positive upward discharges are observed, called “upward strokes”, which are formed during the attachment phase. These upward strokes develop until at least one of them intercepts the downward stroke at a point generally located several dozen meters from the ground. A return arc is then produced, consisting of an intense positive ionization wave that goes up the downward stroke, thus neutralizing a portion of the charge of the cloud.

The protection efficacy of a lightning conductor is thus directly related to the capacity of the capture device to generate an “early” upward stroke that will meet the downward stroke to form the flash, before any other upward stroke comes from the area to be protected. This protection efficacy, which is dependent on a large number of criteria, and, in particular, the height and the shape of the lightning conductor, as well as the presence or absence of a priming device (lightning rod with priming device), is generally evaluated by defining a safety perimeter on the ground, extending around the lightning conductor, and in which an upward stroke cannot be formed that is capable of intercepting, before the upward stroke coming from the lightning conductor, the downward stroke. In general, this safety perimeter is characterized by the lateral distance on the ground separating the lightning conductor from the boundary of the safety perimeter.

An empirical model, called an electrogeometric model (EGM), established some decades ago, makes it possible to determine, according to the height of the capture devices and the intensity of the lightning current, the lateral protection distance, which corresponds to the span of the area of protection covered by the lightning conductor.

This electrogeometric model is prescribed in most, or even all, international standards regarding lightning protection. However, this electrogeometric model, in spite of its great simplicity, is inadequate and limited. Indeed, it has been observed numerous times that installations have been struck by lightning even though, according to the electrogeometric model, they were under the protection of a lightning conductor. Therefore, there is a risk, when installing a lightning conductor according to the prescriptions of the electrogeometric model, of not actually protecting at least some of the area that is to be protected from the direct impact of lightning.

Other methods have since been developed, and, in particular, methods based on mathematical models called “stroke progression models”. The known stroke progression models do not, however, make it possible to obtain precise results in a simple and reliable manner, so they are not included in the international standards.

### SUMMARY OF THE DISCLOSURE

The present invention addresses the various disadvantages of the prior art mentioned above, and provides a method for evaluating the span of the area of protection covered by at least one lightning capture device, which makes it possible to obtain more precise and more reliable results.

A feature of the present invention is to provide a method for evaluating the span of the area of protection covered by at least one lightning capture device, which is based on fine modelling of the physical phenomena governing the formation and development of upward and downward strokes.

Another feature of the present invention is to provide a method for evaluating the span of the area of protection covered by at least one lightning capture device, which is particularly suitable for automated computer implementation.

Another feature of the present invention is to provide a method for evaluating the span of the area of protection covered by at least one lightning capture device, which can be applied to real cases, with good reliability.

The features of the present invention are achieved by a method for evaluating the span of the area of protection covered by at least one lightning capture device, the lightning strike is formed by the propagation and the junction of an upward stroke and a downward stroke, the method is based on a stroke progression model in which each stroke is modelled by a series of electrically charged segments, each segment extending, in the direction of propagation, between a rear end and a front end, the method includes at least one step of verifying the junction between the downward stroke and the upward stroke in which the electrical field is calculated along a fictitious line joining the downward stroke and the upward stroke, and is verified that the electrical field is, everywhere on the fictitious line, higher than the minimum electrical field necessary for the propagation of the upward stroke.

The features of the present invention are also achieved by a computer program including computer program coding means suitable for carrying out the steps of a method according to the present invention, when the program is run on a computer.

The features of the present invention are also achieved by a computer program according to the present invention implemented on a computer-readable medium.

The features of the present invention are also achieved by a medium capable of being read by a computer and on which a program according to the present invention is recorded.

### BRIEF DESCRIPTION OF THE DRAWINGS

Other features and advantages of the invention will appear in greater detail on reading the description with reference to the drawings, which are provided purely for illustrative and non-limiting purposes.

FIG. 1 is a lateral diagrammatic view of the propagation of a downward stroke coming from a cloud and the propagation of an upward stroke coming from a capture device placed on the ground;

FIG. 2 is a lateral diagrammatic view of the propagation of a downward stroke from a cloud;

FIG. 3 diagrammatically shows the formation of an upward predischarge zone (streamer zone) at the apex of a capture device, formed in this case by a point;

FIG. 4 shows the formation of an upward stroke resulting from the formation of the upward predischarge zone shown in FIG. 3;

FIG. 5 is a diagrammatic view of a portion of a stroke and the image of the stroke relative to the ground, which is considered to be an infinitely conductive planar surface;

FIG. 6 is a diagrammatic view of a qualitative comparison between the collection volume of a capture device as evaluated by the method according to one exemplary embodiment of the present invention, and the collection volume as evaluated by a method of the prior art;

FIG. 7 is a diagrammatic perspective view of a building equipped at the apex with a capture device, the building resting on the ground with a storm cloud over it;

FIG. 8 is a diagrammatic perspective view of a phenomenon of competition between four upward strokes with respect to a single downward stroke;

FIG. 9 diagrammatically shows a phenomenon of competition between two capture devices, with the abscissa values corresponding to the lateral distance in meters, and the ordinate values corresponding to the altitude in meters;

FIG. 10 is a diagrammatic view of the competition between two upward strokes coming from two respective capture devices, opposite an oblique downward stroke, with the abscissa values corresponding to the lateral distance in meters, and the ordinate values corresponding to the altitude in meters;

FIG. 11 shows the variation in the distance of protection according to the height of the capture device, for variable lightning current intensities, as well as speed ratios of the variable downward and upward strokes;

FIG. 12 shows a series of curves obtained either by the electrogeometric model or by the method of the present invention, for variable lightning current intensities, the curves showing the variation in the lateral safety distance (ordinate) according to the height of the capture device (abscissa);

FIG. 13 shows, for various speed ratios of the upward and downward strokes, the collection volume of a capture device eight meters high, the altitude being on the ordinate and the lateral distance being on the abscissa;

FIG. 14 shows the variation in the attraction radius (ordinate) of a capture device thirty meters high as a function of the intensity of the lightning current, according to the electrogeometric model and according to the method of the present invention;

FIG. 15 shows a flow chart of an algorithm for digital calculation based on the method of the present invention;

FIG. 16 shows a second flow chart of an algorithm for digital calculation based on the method of the present invention;

FIG. 17 shows a third flow chart of an algorithm for digital calculation based on the method of the present invention;

FIG. 18 shows a fourth flow chart of an algorithm for digital calculation based on the method of the present invention;

FIG. 19 shows a fifth flow chart of an algorithm for digital calculation based on the method of the present invention;

FIG. 20 shows a sixth flow chart of an algorithm for digital calculation based on the method of the present invention; and

FIG. 21 shows a seventh flow chart of an algorithm for digital calculation based on the method of the present invention.

### DETAILED DESCRIPTION OF THE EMBODIMENTS

The present invention relates to a method for evaluating the span of protection covered by at least one lightning capture device 1, 1A, 1B, 1C.

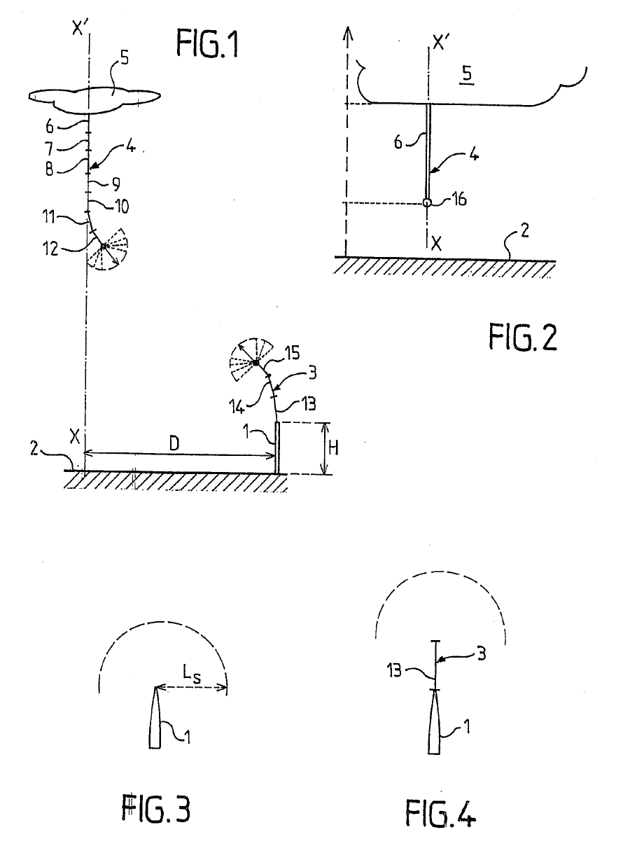

In particular, the method according to the present invention makes it possible to determine the lateral distance of protection D covered by one or more capture devices 1, 1A, 1B, 1C. As shown in FIG. 1, the lateral distance of protection D corresponds to the maximum distance, measured at the ground 2, which marks the boundary of a safety perimeter around the capture device 1, in which perimeter any object, person, building, structure or equipment is placed under the protection of the capture device 1. In other words, the lateral safety distance D, which is well known to a person skilled in the art, corresponds to the radius of a disk centered on the capture device and in which any direct lightning impact is eliminated, with the sole exception of impacts located exclusively on the capture device 1.

The method according to the present invention can be implemented regardless of the number, the location in space and the nature of the lightning capture devices 1, 1A, 1B, 1C.

In particular, the method of the present invention can be applied to single-rod lightning conductors or lightning conductors with a priming device, multipoint devices or meshed cages.

The method can be applied to an assembly composed of a plurality of lightning capture devices, the devices are positioned, for example, three-dimensionally, with respect to one another.

The method according to the present invention is advantageously a three-dimensional method. Of course, the method can be applied to two-dimensional situations, without going beyond the scope of the present invention.

The lightning to be captured by the capture device 1, 1A, 1B, 1C is formed by the propagation and the junction of an upward stroke 3, 3A, 3B, 3C and a downward stroke 4, the upward stroke 3, 3A, 3B, 3C is primed and propagated from the capture device 1, while the downward stroke 4 originates at the base of a storm cloud 5.

The interception of the downward stroke 4 by the upward stroke 3, and the junction of the strokes 3, 4 form the flash and the lightning strike. The phenomenon of the lightning strike at this level is well known to a person skilled in the art and will not be described in greater detail.

However, it is noted that the lateral safety distance D can correspond to the maximum distance, measured at the ground, separating the capture devices 1 from the axis X-X′ along which the downward stroke 4 extends, at its origin, the downward stroke 4 (cf. FIG. 1) is capable of being intercepted by the upward stroke 3 coming from the capture device 1.

The method according to the present invention is based on a stroke progression model. Stroke progression models are well known to a person skilled in the art, and will not be described in greater detail. It will simply be noted that in such a stroke progression model, each stroke 3, 3A, 3B, 3C, 4 is modelled by a series of electrically charged segments 6, 7, 8, 9, 10, 11, 12, 13, 14, 15, each segment 6, 7, 8, 9, 10, 11, 12, 13, 14, 15 extending, in the direction of propagation, between a rear end and a front end, with the front end of a given segment corresponding to the rear end of another segment following it.

Conventionally, each segment is a straight segment of zero thickness and constant length, the segment length corresponding to a stroke step.

Conventionally, the segments 13, 14, 15 corresponding to the upward stroke 3 carry a positive electrical charge, while the segments 6, 7, 8, 9, 10, 11, 12 corresponding to the downward stroke 4 carry a negative electrical charge.

Preferably, the ground 2 is considered to be an infinitely planar conductive surface capable of taking into account the influence of the image charges, as will be seen below.

The method according to the present invention advantageously includes a step of applying a criterion for priming the upward stroke 3.

In this step, a calculation of the threshold field, i.e., the minimum electrical field necessary for the propagation of the upward stroke 3, is performed, to determine the threshold field according to the height H of the capture device 1 with respect to the ground 2.

In other words, once the ambient atmospheric electrical field reaches or exceeds the threshold field, the upward stroke 3 can be produced.

According to the present invention, when the height H of the capture device, preferably formed by a pointed metal rod, is substantially lower than six meters, the Rizk criterion is applied, so that the threshold field E_{R}, expressed in kV/m, is obtained by the following formula:

$${E}_{R} = \frac{1556}{H + 3 , 89}$$

If the height of the capture device 1 is substantially higher than six meters, then the Lalande criterion is applied according to the present invention. According to this criterion, the threshold field E_{L}, expressed in kV/m, is obtained by the following formula:

$${E}_{L} = \frac{240}{1 + 0 , 1 H} + 12$$

In this context of the method according to the present invention, it is considered that a semispherical upward predischarge zone (or streamer zone) with a predetermined radius L_{S} is formed at the upper end of the capture device 1, i.e., at the level of the point of the rod when the capture device 1 is a lightning conductor. It is noted in passing that the radius of curvature of the point of the capture device is preferably considered in this case to be very small.

This streamer zone, which carries a distributed electrical charge of value Q, extends from the apex of the rod of the lightning conductor over the distance L_{S}, where the intensity of the electrical field reaches a value E_{S} (cf. FIG. 3). When the field E_{S} reaches the threshold value, namely E_{R} or E_{L} according to the shape of the capture device 1, an upward stroke 3 is primed, i.e., a first segment 13 extends from the capture device 1 (cf. FIG. 1). The segment 13 generates the formation of a new streamer zone, which gives rise to a second segment 14 consecutive to the first, and so on.

Such a modelling has already been described in general in the prior art, so it is unnecessary to describe it in greater detail here.

Advantageously, in the context of the method according to the present invention, for the downward stroke, the field E_{S} will be set at a threshold value substantially equal to 1100 kV/m. For the upward stroke, the field E_{S} will be set at a threshold value substantially equal to 500 kV/m.

The method according to the present invention advantageously includes a step of modelling the electrical charge of the strokes, in which each segment 6, 7, 8, 9, 10, 11, 12, 13, 14, 15 is associated with a linear charge distribution λ and a point charge 16, of value Q′, located at the front end of the segment concerned (cf. FIG. 2).

If it is considered that the streamer zone, which develops at the apex of the capture device (cf. FIG. 3) is like a semisphere with a radius L_{S}, we then have the following relation:

$${E}_{S} = \frac{Q}{2 πɛ {oL}_{S}^{2}}$$

wherein E_{S} is in V/m, and εo is the absolute permittivity of the vacuum.

When the streamer zone advances by a step (shown in FIG. 4), the charge Q of the streamer zone is distributed over a segment of length L_{S}. Then, the above formula is written:

$${E}_{S} = \frac{λ {L}_{S}}{2 πɛ {oL}_{S}^{2}} = \frac{λ}{2 πɛ {oL}_{S}}$$

The value Q′ of the point charge 16 will therefore be:

Q′=Q=L_{S}=2πεoL_{S}²E_{S}=λ²/(2πεoE_{S})

Advantageously, for each segment 6, 7, 8, 9, 10, 11, 12, 13, 14, 15, the linear charge distribution λ is substantially uniform, while the value of the point charge 16 is substantially constant.

According to the present invention, the previous formula is combined with the following relation, proposed by Petrov and Waters:

λd=0,43.10⁻⁶I^{2/3}

where I is the intensity of the lightning current,
while setting the value of E_{S} at 1100 kV/m, to arrive at a point charge value Q_{d} for the downward stroke:

Q_{d}=3,33.10⁻⁹I^{4/3}

where I is the intensity of the lightning current (in kA).

In the context of the method according to the present invention, the upward stroke has a minimum but necessary charge density λₐₘᵢₙ for the priming and the formation of the stroke.

This value will preferably be between 20 and 70 μC/m, and is preferably substantially equal to 50 μC/m.

The point charge Qₐ corresponding to the upward stroke, is obtained using the following formula:

Qₐ=λₐₘᵢₙ/(2=πε_{O}E_{S})avec E_{S}=500 kV/m

with E_{S}=500 kV/m

The original charge distribution model described above is independent of the other features of the method according to the present invention, and can constitute an invention as such.

The method according to the present invention advantageously includes a step of modelling the speed of the upward strokes 3, 3A, 3B, 3C and the downward stroke 4, in which the upward and downward strokes are propagated at a constant speed, when the upward stroke 3, 3A, 3B, 3C is primed from the corresponding capture device 1, 1A, 1B, 1C.

Preferably, the propagation speeds of the upward strokes V_{asc} and downward strokes V_{des} are taken into consideration in the method according to the present invention by introducing the speed ration R_{V}:

$$\frac{{V}_{des}}{{V}_{asc}} = \frac{{L}_{des} / Δ t}{{L}_{asc} / Δ t} = {L}_{des} / {L}_{asc} = {R}_{V}$$

wherein L_{des} and L_{asc} respectively represent the propagation steps of the downward 4 and upward 3 strokes, with the steps corresponding to the length of a unit segment 6, 7, 8, 9, 10, 11, 12, 13, 14, 15.

Preferably, the propagation speed V_{des} of the downward stroke 4 is considered to be constant. In other words, when the method of the present invention is implemented, the step of the downward stroke is preferably fixed, while the step of the upward stroke 3 needs to be determined.

Advantageously, the ratio R_{V} of the propagation speed of the downward stroke 4 to the propagation speed of the upward stroke 3 is substantially between 0.1 and 8, and is preferably substantially between 0.5 and 4.

This last range of values makes it possible to best approach the conditions encountered in reality, and enables more reliable results to be obtained.

The method according to the present invention advantageously includes a step of modelling the priming delay Δt of the capture device 1, in which step it is considered that when the minimum electrical field needed for the propagation of the upward stroke 3 is reached (or exceeded), the upward stroke 3 will not be primed, as long as the downward stroke 4 has not progressed by a distance equal to the product of the priming delay Δt and the speed V_{des} of the downward stroke 4.

This step of modelling the priming delay, like the step of modelling the speed described above, is independent of the rest of the present invention and can constitute a separate invention.

The method according to the present invention advantageously includes a step of calculating the electrical potential and field.

The progression of this step differs depending on whether the capture device 1, 1A, 1B, 1C is placed directly on the ground 2 (cf. FIG. 1) or on a corresponding superstructure 17, the superstructure rising from the ground 2 to have a non-zero altitude, and preferably a relatively high altitude.

For purposes of the present disclosure, the term “superstructure” means any building, whether designed for housing or an industrial or commercial activity, or any natural or artificial building, or even any equipment, of any type whatsoever, which is to be protected from the direct impact of lightning.

By construction, such a superstructure 17 will have geometric protrusions, i.e., areas of sudden changes in geometry, such as edges or corners, the geometric protrusions are suitable for the generation of upward strokes.

First, we will describe in detail a preferred method for calculating the potential and the field in the case of a capture device 1, 1A, 1B, 1C formed by a pointed rod, resting on the ground 2. As described above, the ground 2 is considered to be an infinitely conductive planar surface capable of taking into account the influence of the image charges.

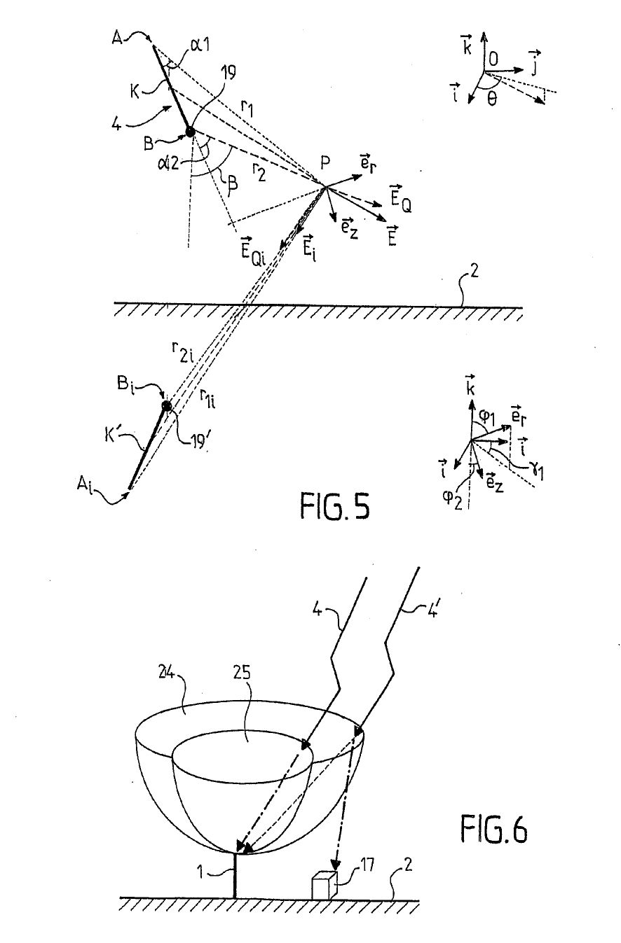

As shown in FIG. 5, the field and the potential are preferably calculated in a local point (o, \vec{e}ᵣ, \vec{e}_{z}) then expressed in the global point (o, \vec{i}, \vec{j}, \vec{k}) FIG. 6 shows a segment K of a stroke extending from a rear end A to a front end B. This same figure shows the image segment K′ with respect to the ground 2.

The segment K has a linear charge λ and a point charge 19 located at the front end B and having a charge value Q.

The image segment K′ has a linear charge −λ and a point charge 19′ of which the value is −Q.

Consequently, and according to the geometric arrangement shown in FIG. 5, the potential created at a point P (centre of the local point (o, \vec{e}ᵣ, \vec{e}_{z}))) by the linear charge and the image is obtained by the following formula:

$${V}_{K} ( P ) = \frac{λ}{4 πɛ} ln ( c \frac{a + c}{a - c} \times \frac{{a}_{i} -}{{a}_{i} +} )$$

where the length of the segment K is equal to 2C, while r1+r2=2a and r1ᵢ+r2ᵢ=2ₐᵢ.

The potential at point P due to the point charge 19 located at the head of the stroke K, and image 19′ is given by the expression:

$${V}_{Q} ( P ) = \frac{Q}{4 πɛ o} ( \frac{1}{{r}_{2}} - \frac{1}{{r}_{2 i}} )$$

Consequently, the total potential V_{T} at point P due to all of the stroke segments, the point charge and their respective images is written:

$${V}_{T} ( P ) = {V}_{Q} ( P ) + {\sum }_{K} {V}_{k} ( P )$$

Preferably, according to the method of the present invention, the tangential and normal components of the field due to a stroke segment K, as well as the field due to the point charge and image, are calculated.

The tangential components are written as follows:

$${\vec{E}}_{z} = \frac{λ}{4 π {∈}_{0}} ( \frac{1}{{r}_{2}} - \frac{1}{{r}_{1}} ) {\vec{e}}_{z}$$

$${\vec{E}}_{zi} = \frac{- λ}{4 π {∈}_{0}} ( \frac{1}{{r}_{2 i}} - \frac{1}{{r}_{1 i}} ) {\vec{e}}_{zi}$$

The normal components are written as follows:

$${\vec{E}}_{r} = \frac{λ}{4 π {∈}_{0}} [ \frac{tan ( {α}_{1} / 2 )}{{r}_{1}} - \frac{tan ( {α}_{2} / 2 )}{{r}_{2}} ] {\vec{e}}_{r}$$

The normal and tangential components are expressed as follows in the global point (o, \vec{i}, \vec{j}, \vec{k}):

\vec{E}ᵢ=sin(φ1)cos(γ1)\vec{E}ᵣ+sin(φ1i)cos(γ1i)\vec{e}ᵣᵢ+sin(φ2)cos(γ2)\vec{e}_{z}+sin(φ2i)cos(γ2i)\vec{e}_{zi}

\vec{E}ⱼ=sin(φ1)sin(γ1)\vec{e}ᵣ+sin(φ1i)sin(γ1i)\vec{e}ᵣᵢ+sin(φ2)sin(γ2)\vec{e}_{z}+sin(φ2i)sin(γ2i)\vec{e}_{zi}

\vec{E}ₖ=cos(φ1)\vec{e}ᵣ−cos(φ1i)\vec{e}ᵣᵢ−cos(φ2)\vec{e}_{z}+cos(φ2i)\vec{e}_{zi}

\vec{E}_{K}(P)=\vec{E}ᵢ+\vec{E}ⱼ+\vec{E}ₖ

The field due to the point charge and image is written:

$${\vec{E}}_{Q} = \frac{Q}{4 π {∈}_{0} {r}_{2}^{2}} ( cos ( θ ) sin ( β ) \vec{i} + sin ( θ ) sin ( β ) \vec{j} - cos ( β ) \vec{k} )$$

$${\vec{E}}_{iQ} = \frac{- Q}{4 π {∈}_{0} {r}_{2}^{2}} ( cos ( {θ}_{i} ) sin ( {β}_{i} ) \vec{i} + sin ( {θ}_{i} ) sin ( {β}_{i} ) \vec{j} + cos ( {β}_{i} ) \vec{k} )$$

Therefore: \vec{E}_{Q} (P)=\vec{E}_{Q}+\vec{E}_{iQ}

The total electrical field at point P due to the stroke is written:

$${\vec{E}}_{T} ( P ) = {\vec{E}}_{Q} ( P ) + {\sum }_{k} {\vec{E}}_{k} ( P )$$

If the capture device 1, 1A, 1B, 1C is arranged on a superstructure 17 elevated above the ground 2, the potential is determined by solving the Laplace equation:

−∇(εo∇V)=0

The Laplace equation will preferably be solved by finite-element analysis. For example, the calculation can be performed using the FEMLAB™ software sold by the COMSOL company.

A person skilled in the art will be capable of adapting the program and the method, by choosing, in particular, a solution domain and by imposing boundary conditions.

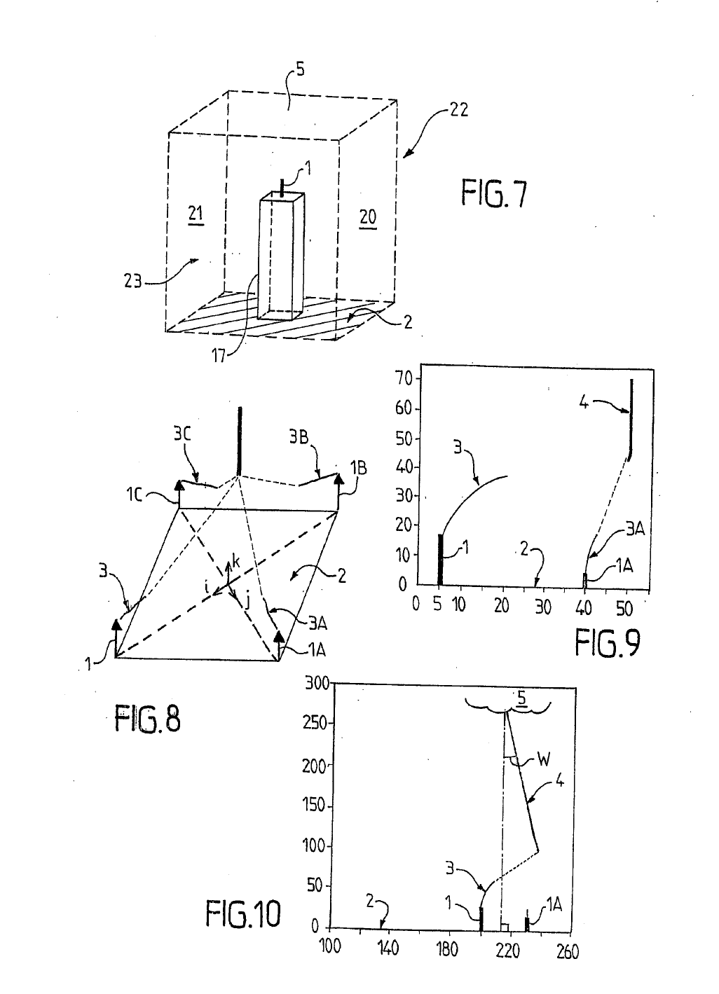

In the context of the example shown in FIG. 7, an elevated structure 17, namely, for example, a concrete building, is protected by a capture device 1, constituted in this case by a metal rod. This superstructure 17 is inside a domain defined by six planes forming a parallelepiped dummy volume.

In the context of the method, it is assumed that the lower plane, which represents the ground 2, from which the building 17 rises, is brought to a zero potential, while the opposite upper plane, which shows the base of a storm cloud 5, has a potential Vₙ (Dirichlet-type conditions).

It is preferably assumed that the other planes 20, 21, 22, 23 are isolated surfaces, which is mathematically translated by: n∇V=0.

Thus, the distribution of the field lines will not be disturbed by the presence of these planes.

The building as well as the rod are also brought to the potential V=0.

Preferably, digital adaptive gridding is performed by refining the digital adaptive gridding in the places where the potential comprises significant gradients (around irregularities such as corners or edges) and by making sure that the digital adaptive gridding does not comprise sudden variations.

Therefore, it is simply necessary to solve the Laplace equation in the domain using the problem-solving module (solver) of a finite-element analysis program, such as the FEMLAB™ program, by imposing the desired precision, according to the general knowledge of a person skilled in the art. The electrical field as well as the potential at any point in the domain will thus be calculated.

The method according to the present invention advantageously includes a step of determining the direction of propagation of the upward stroke 2 and the downward stroke 4.

In this step, the electrical field is preferably calculated at a plurality of points equidistant from the head of the segment concerned, as is shown in FIG. 1. The direction of propagation of the stroke concerned corresponds to the direction of the point, in view of the front end of the segment, for which the electrical field is maximal.

Each stroke advances by a step in the direction of the point for which the field is maximal.

According to an important feature of the present invention, the method includes a step of verifying the junction between the downward stroke 4 and the upward stroke 3, in which step the electrical field is calculated along a fictitious line joining the downward stroke 4 and the upward stroke 3, and is verified that the electrical field is, everywhere on the fictitious line, greater than the minimum electrical field necessary for the propagation of the upward stroke 3.

The fictitious line is preferably a straight segment.

The application of this interception criterion, in the context of the method according to the present invention, is original and is independent of the rest of the invention, so that it can constitute a distinct invention.

The minimum electrical field necessary for the propagation of the upward stroke 3 is advantageously between 200 and 800 kV/m, and is preferably substantially equal to 500 kV/m.

When in the presence of high structures, i.e., superstructures vertically extending from the ground 2, a plurality of lightning impact points are possible, namely, in particular, at the corners and edges of each superstructure. When one or more capture devices 1, 1A, 1B, 1C are placed on the superstructure, the superstructure is theoretically protected and the lightning will be captured only by the capture devices. Nevertheless, in spite of the presence of capture devices 1, 1A, 1B, 1C, the capture devices are sometimes ineffective since the superstructure can be struck by lightning at its corners or edges.

Consequently, the method according to the present invention advantageously includes a step of verifying the priming of an upward stroke 3 from each of the protrusions of the superstructure 17 on which the capture device 1, 1A, 1B, 1C is placed.

In the context of the present invention, the corners of the superstructures will preferably be modelled by spheres, and the edges by cylinders, with low radii of curvature, so that the electrical field can be determined.

The criterion for production of upward strokes, described above, can then be applied and taken into consideration in the method for calculating the lateral safety distance.

Advantageously, the method according to the present invention is a digital method, intended to be programmed in order to form a software program for evaluating the span of the area of protection covered by at least one lightning capture device. The computer program according to the present invention makes it possible, from the number of lightning capture devices as well as their coordinates (height, position), the dimensions of the superstructures to be protected, the priming delay time of the capture devices, the initial coordinates of the downward stroke, the propagation speed of the downward stroke, the speed ratio R_{V} and the intensity of the lightning current, to determine the lateral distance of protection, in two- or three-dimensionally, for a planar configuration or any configuration (for example, composed of one or more buildings, three-dimensionally). The program allows for better lightning protection and optimization of the number of capture devices.

Thus, the use of the method according to the present invention makes it possible to overcome the defects of the electrogeometric model, as well as those of the other digital methods, such as the collection volume method.

In particular, the attractive radius of the collection volume 24 obtained by the methods of the prior art is higher than the collection volume 25 obtained by the method according to the present invention. This difference is accentuated for high currents.

Consequently, as shown in FIG. 6, two laterally distant strokes 4, 4′ will both be intercepted by the capture device 1 according to the collection volume method of the prior art, while, according to the method of the present invention, one of the strokes will effectively be intercepted by the capture device 1, while the other will escape the collection volume and strike the superstructure 17 to be protected.

The method according to the present invention makes it possible to draw attention to dangerous situations, while this was impossible with the methods of the prior art.

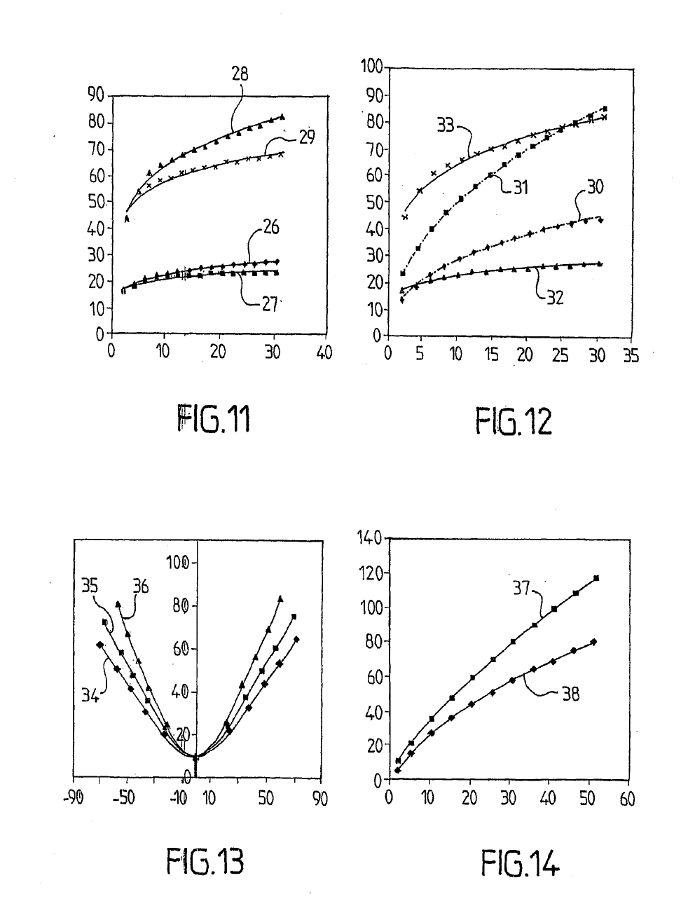

Advantageously, the downward stroke 4 has, at its origin, i.e., when it is primed, an oblique incidence with respect to the vertical direction, i.e., to the normal with respect to the ground 2. The downward stroke 4 is angularly offset by an angle W relative to the vertical direction, as shown in FIG. 10.

FIG. 10 also shows, as do FIGS. 8 and 9, examples of competition between different upward strokes, the competition is capable of being entirely taken into account by the method according to the present invention.

FIGS. 11-14 show some results obtained with the method according to the present invention.

FIG. 11 shows the variation in the lateral distance of protection (expressed in meters on the ordinate) as a function of the height of the rod forming the capture device, for various lightning intensities and various speed ratios R_{V}.

The curve 26 corresponds to an intensity equal to 10 kA, while R_{V}=1. The curve 27 corresponds to an intensity equal to 10 kA, while R_{V}=2. For the curve 28, the intensity is equal to 50 kA, while R_{V}=1. For the curve 29, the intensity is equal to 50 kA while R_{V}=2.

FIG. 12 shows a comparison of the lateral distances calculated according to the method of the present invention (R_{V} being set at 1) and according to the electrogeometric model, for various lightning current intensity values. The lateral distance is on the ordinate (in meters) while the height of the capture device, formed in this case by a rod, is on the abscissa (in meters). The curve 30 corresponds to a result obtained by the electrogeometric model when the intensity is equal to 10 kA. The curve 31 corresponds to a result obtained by the electrogeometric model when the intensity is equal to 50 kA. The curve 32 corresponds to a result obtained by the method according to the present invention, when the intensity is equal to 10 kA, while the curve 33 corresponds to a result obtained according to the method of the present invention when the intensity is equal to 50 kA.

FIG. 13 shows the collection volume obtained with a capture device formed by a rod eight meters high, for various lightning current intensity values and various speed ratios R_{V}. The abscissa shows the lateral distance to the ground, while the ordinate shows the altitude. The curves 34, 35, 36 correspond respectively to ratios R_{V}=½, 1 and 2.

FIG. 14 finally shows a comparison between the radius of attraction of the collection volume calculated with the method according to the present invention and with the Ericksson model, for a capture device formed by a rod thirty meters high. The radius of attraction is on the ordinate in meters, while the lightning current intensity (in kA) is on the abscissa. The curve 37 corresponds to the result obtained by the method according to the present invention, while the curve 38 corresponds to the result obtained by the Ericksson model.

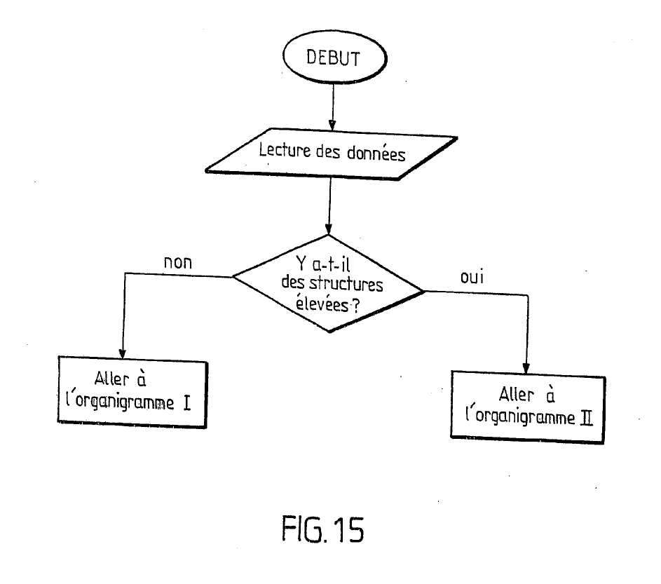

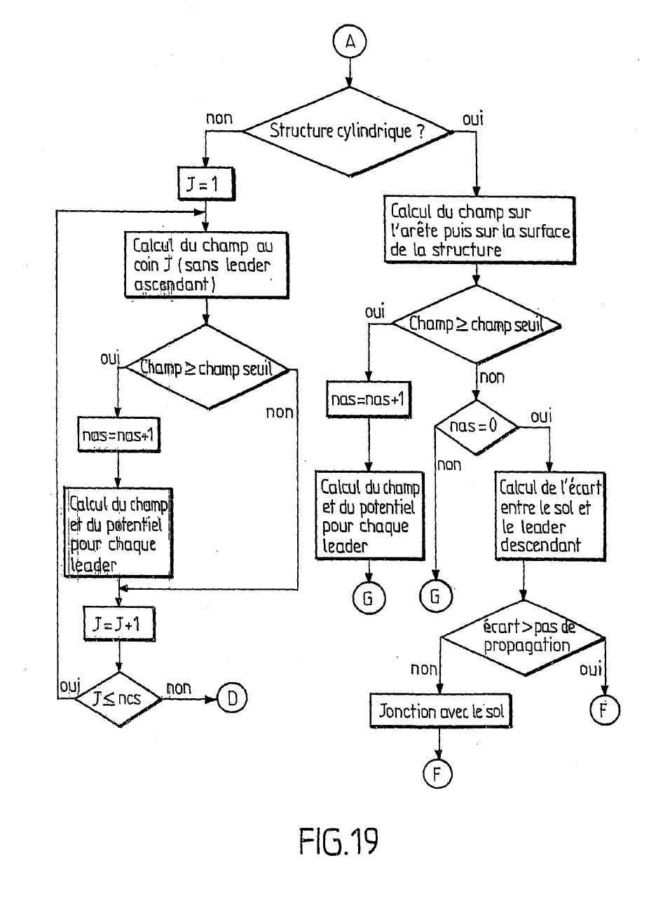

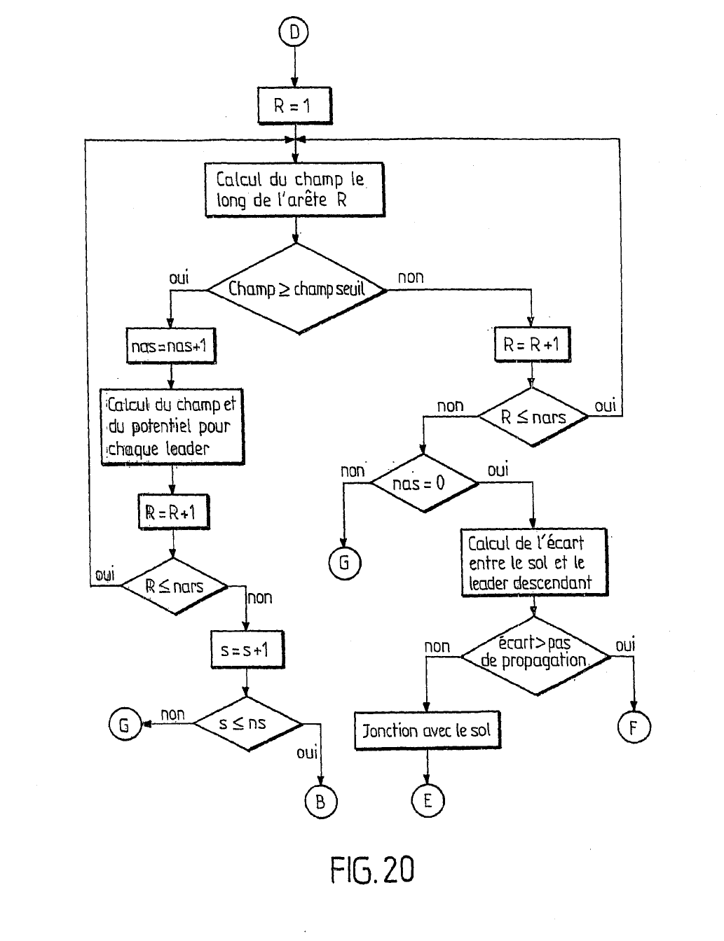

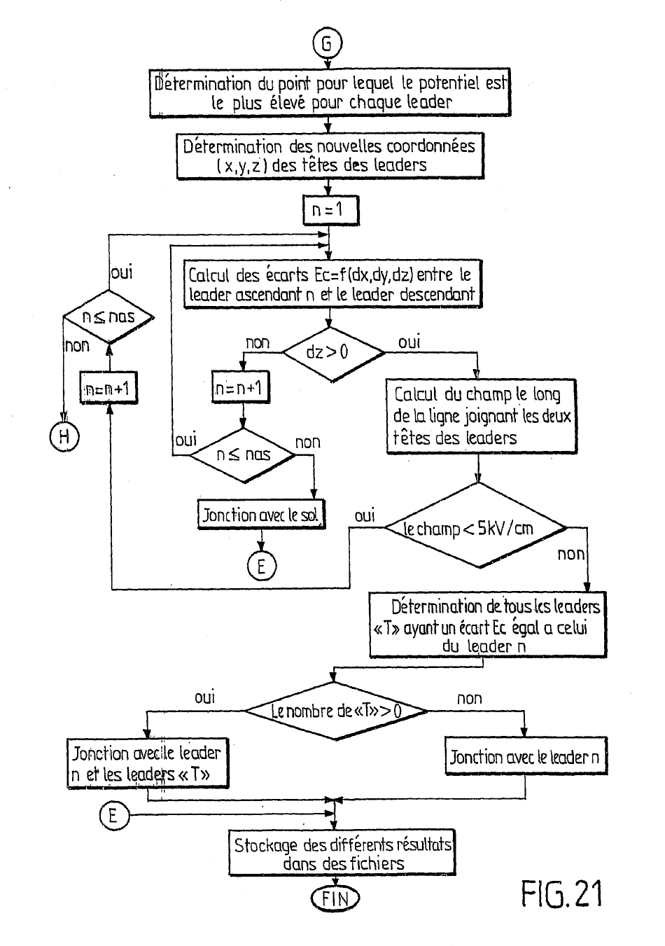

As mentioned above, the method according to the present invention is particularly suitable for computer programming. FIGS. 15-21 show a flow chart of an algorithm for implementing the method according to the present invention.

It should be noted that, if the superstructures have spherical or cylindrical shapes, and in the absence of corners and edges, the calculation of the field will be done for the entire rounded surface by applying the same production and junction criteria as those mentioned above.

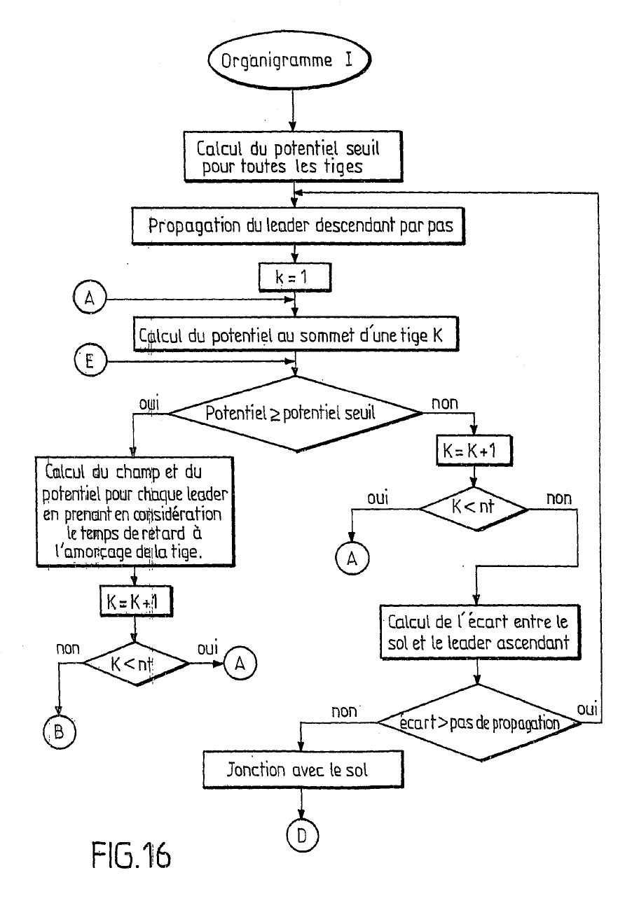

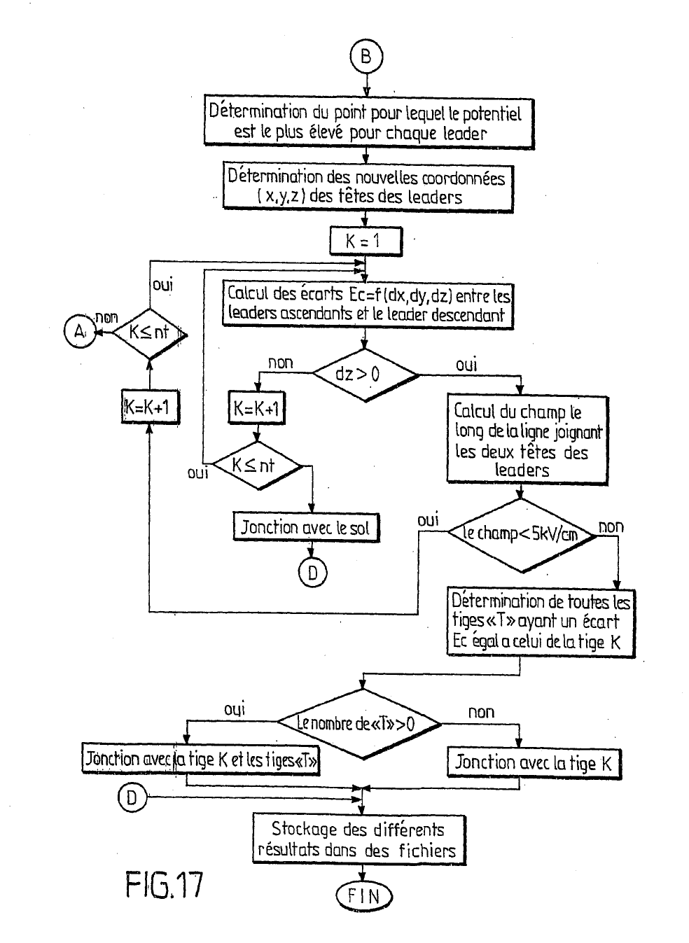

In the flow chart I shown in FIG. 16, nt represents the number of rods, while K corresponds to the rod number.

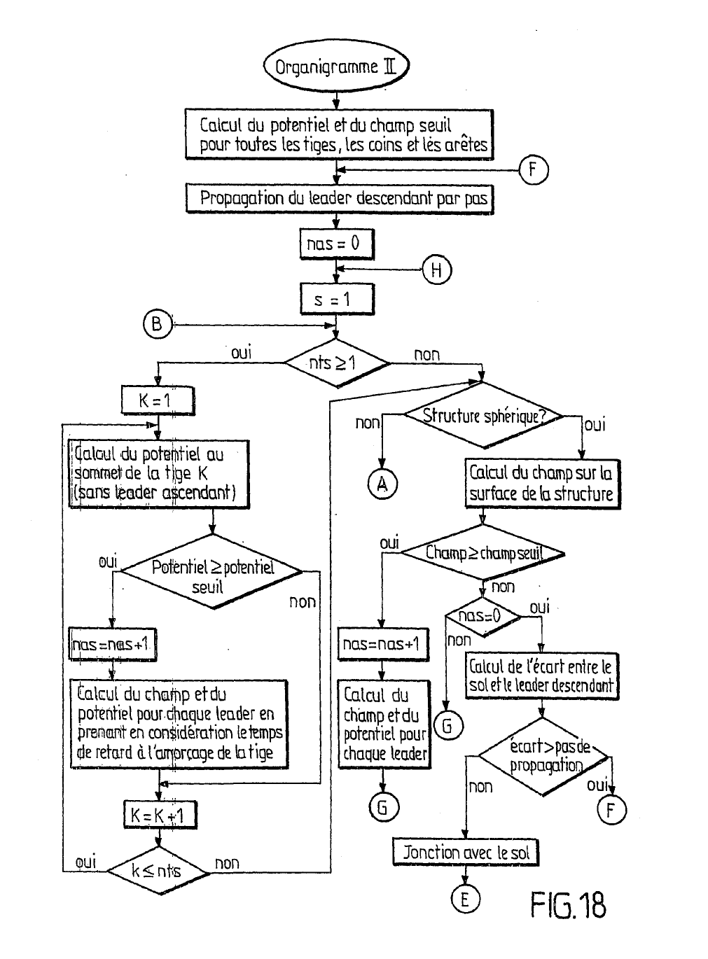

In addition, in the flow chart II shown in FIG. 18, ns corresponds to the number of superstructures, also called “high structures”, s is the number of the structure, nts is the number of rods on the structure, K is the number of a rod, ncs is the number of corners on the structure s, J is the number of the corner, nars is the number of edges on the structure s, R is the number of the edge, Nas is the number of upward strokes and n is the number of the upward stroke.

The present invention also relates to a computer program for implementing the method described above, as well as a storage medium on which such a program is stored.

More specifically, the present invention relates to a computer program including computer program coding means suitable for carrying out the steps of a method according to the present invention, as described above, when the program is run on a computer.

The computer program is preferably suitable for carrying out all of the steps of the method. The computer program can be produced with any code known to a person skilled in the art, and, in particular, using a code implementing advantageously three-dimensional finite-element modelling.

The present invention also relates to a computer program according to the present invention implemented on a computer-readable medium, such as a magnetic disk (hard disk or CD-ROM, for example).

The present invention finally relates to a medium, for example, a hard disk or a CD-ROM, capable of being read by a computer and on which a program according to the present invention is recorded.

Finally, the method according to the present invention, by finely modelling the three necessary conditions for successful lightning capture (formation of an upward stroke, stable propagation of the upward stroke to meet the downward stroke, and successful junction of the two strokes) makes it possible to calculate with excellent accuracy the safety distance, which makes it possible to increase the reliability and safety of protection installations.

The present invention can be used in the design and implementation, in particular computerized, of a method for evaluating the span of the area of protection covered by a lightning capture device.

1. A method for evaluating the span of the area of protection covered by at least one lightning capture device, the lightning strike is formed by the propagation and the junction of an upward stroke and a downward stroke, the method being based on a stroke progression model in which each stroke is modelled by a series of electrically charged segments, each segment extending, in the direction of propagation, between a rear end and a front end, the method comprising:
(a) verifying the junction between the downward stroke and the upward stroke;
(b) calculating the electrical field along a fictitious line joining the downward stroke and the upward stroke; and
(c) verifying that the electrical field is, everywhere on the fictitious line, higher than the minimum electrical field necessary for the propagation of the upward stroke.

2. The method of claim 1, wherein the fictitious line is a straight segment.

3. The method of claim 1, wherein the minimum electrical field necessary for the propagation of the upward stroke is between 200 and 800 kV/m.

4. The method of claim 1, further comprising a step of modelling the electrical charge of the strokes, in which each segment is associated with a linear charge distribution (λ) and a point charge located at the front end of the segment concerned.

5. The method of claim 4, wherein the linear charge distribution (λ) is substantially uniform for each segment, while the point charge is substantially constant.

6. The method of claim 4, wherein the linear charge distribution (λ) for each upward stroke segment is between 20 and 70 μC/m.

7. The method of claim 1, further comprising a step of modelling the speed of the upward and downward strokes, in which the upward and downward strokes are propagated at a constant speed, when the upward stroke is primed.

8. The method of claim 7, wherein the propagation speed of the downward stroke is constant.

9. The method of claim 7, wherein the ratio of the propagation speed of the downward stroke over the propagation speed of the upward stroke is substantially between 0.1 and 8.

10. The method of claim 1, further comprising a step of modelling the priming delay of the capture device, in that when the minimum electrical field needed for the propagation of the upward stroke is reached, the upward stroke will not be primed as long as the downward stroke has not progressed by a distance equal to the product of the priming delay and the speed of the downward stroke.

11. The method of claim 1, wherein at least one capture device is placed on the ground.

12. The method of claim 1, wherein at least one capture device rests on a corresponding superstructure, the superstructure having geometric protuberances, such as edges or corners.

13. The method of claim 12, further comprising a step of verifying the priming of an upward stroke from each of the protuberances.

14. The method of claim 1, wherein the downward stroke is propagated, when it is primed, in an oblique direction with respect to the normal to the ground.

15. The method of claim 1, further comprising a two-dimensional digital method.

16. The method of claim 1, further comprising a three-dimensional digital method.

17. A computer program including computer program coding means suitable for carrying out the steps of a method for evaluating the span of the area of protection covered by at least one lightning capture device, the lightning strike is formed by the propagation and the junction of an upward stroke and a downward stroke, the method being based on a stroke progression model in which each stroke is modelled by a series of electrically charged segments, each segment extending, in the direction of propagation, between a rear end and a front end, the method comprising:
(a) verifying the junction between the downward stroke and the upward stroke;
(b) calculating the electrical field along a fictitious line joining the downward stroke and the upward stroke; and
(c) verifying that the electrical field is, everywhere on the fictitious line, higher than the minimum electrical field necessary for the propagation of the upward stroke.

18. The computer program of claim 17, implemented on a computer-readable medium.

19. A medium capable of being read by a computer and on which a computer program is recorded, the computer program including coding means suitable for carrying out the steps of a method for evaluating the span of the area of protection covered by at least one lightning capture device, the lightning strike is formed by the propagation and the junction of an upward stroke and a downward stroke, the method being based on a stroke progression model in which each stroke is modelled by a series of electrically charged segments, each segment extending, in the direction of propagation, between a rear end and a front end, the method comprising:
(a) verifying the junction between the downward stroke and the upward stroke;
(b) calculating the electrical field along a fictitious line joining the downward stroke and the upward stroke; and
(c) verifying that the electrical field is, everywhere on the fictitious line, higher than the minimum electrical field necessary for the propagation of the upward stroke.
